(19) United States
(12) Patent Application Publication
(10) Pub. No.: US 2026/0169133 A1
(43) Pub. Date: Jun. 18, 2026

(54) LAMP ASSEMBLY AND VEHICLE INCLUDING SAME

(71) Applicants: HYUNDAI MOTOR COMPANY, SEOUL (KR); KIA CORPORATION, SEOUL (KR); SL CORPORATION, GYEONGSAN-SI (KR)

(72) Inventors: Hyeong Seon Kim, Hwaseong-si (KR); Tae Wan Kim, Gyeongsan-si (KR)

(73) Assignees: HYUNDAI MOTOR COMPANY, SEOUL (KR); KIA CORPORATION, SEOUL (KR); SL CORPORATION, GYEONGSAN-SI (KR)

(21) Appl. No.: 19/228,040

(22) Filed: Jun. 4, 2025

(30) Foreign Application Priority Data
Dec. 18, 2024 (KR) 10-2024-0190373

(51) Int. Cl. G01S 7/481; G01S 17/931

(52) U.S. Cl. CPC G01S 7/4814; G01S 7/4813; G01S 17/931

(57) ABSTRACT

A lamp assembly includes a light source, a light guide through which light from the light source passes, and a LiDAR sensor. A light-emitting portion and a cover portion spaced apart from the light-emitting portion are positioned on the light guide, the LiDAR sensor is positioned behind the cover portion, and an edge region of the cover portion is a corrosion-treated corrosion surface.

### CROSS REFERENCE TO RELATED APPLICATIONS

This application claims benefit of priority to Korean Patent Application No. 10-2024-0190373 filed on Dec. 18, 2024 in the Korean Intellectual Property Office, the disclosure of which is incorporated herein by reference in its entirety.

### BACKGROUND

### 1. Field

The present disclosure relates to a lamp assembly and a vehicle including the same.

### 2. Description of Related Art

Currently, various lamp assemblies for securing visibility in front and rear directions, and for indicating a turn signal and a state of braking are provided in a vehicle. The lamp assemblies generally include a headlamp located in a front portion of the vehicle, a tail lamp located in a rear portion of the vehicle, a side lamp for a turn signal indicator, and the like, and play an important role in securing a driver's field of vision and conveying movement information of the vehicle to other drivers.

Recently, with the development of autonomous driving and advanced driver assistance system (ADAS) technology, the need for technology that may recognize an environment around the vehicle is increasing. In particular, technology such as a LiDAR sensor for sensing an object and an obstacle around the vehicle plays an important role in an autonomous driving system, and is widely used to improve safety of the vehicle. The LiDAR sensor senses a surrounding object through an infrared signal and provides a function that may analyze a situation around the vehicle in real time.

However, when the existing LiDAR sensor is installed in a separate space, design constraints on an exterior of the vehicle may occur, and a size and design complexity of the vehicle may increase.

Therefore, improved technology capable of efficiently utilizing a space by embedding a LiDAR sensor in the existing lamp assembly, while solving reflection or interference problems of the sensor and protecting the sensor, is required.

### SUMMARY

In order to solve at least a portion of the above problems, a lamp assembly according to the present embodiment may include a LiDAR sensor to use surroundings of a cover portion acting as a black cover of the LiDAR sensor, as a lamp, may adjust a sensing range of the LiDAR sensor, and may reduce a ghost phenomenon of the LiDAR sensor.

The purpose of the present disclosure is not limited to the purposes mentioned above, and other purposes not mentioned can be clearly understood by those skilled in the art to which the present disclosure belongs from the description below.

According to an aspect of the present disclosure, a lamp assembly includes a light source, a light guide through which light from the light source passes, and a LiDAR sensor, wherein a light-emitting portion and a cover portion disposed to be spaced apart from the light-emitting portion are disposed on the light guide, the LiDAR sensor is disposed behind the cover portion, and an edge region of the cover portion is a corrosion-treated corrosion surface.

The lamp assembly may further include a bezel unit disposed in front of the light guide, wherein a first window may be disposed in the bezel unit aligned with an optical axis direction of the LiDAR sensor and the cover portion, and an area of the first window may be greater than an area of the cover portion.

The edge region of the cover portion may be visible through the first window.

A surface of the light-emitting portion may be a corrosion-treated corrosion surface.

The lamp assembly may further include a lens unit disposed between the light guide and the bezel unit.

A lens cell may be disposed in the lens unit, and the lens cell may be disposed to face the light-emitting portion.

The LiDAR sensor may directly face the cover portion.

A front portion of the cover portion may be convexly curved.

The cover portion may be disposed obliquely.

The cover portion may form a tilt angle with a virtual plane, perpendicular to an optical axis of the LiDAR sensor.

The cover portion may form an obtuse angle with an optical axis of the LiDAR sensor.

The lamp assembly may further include a frame disposed between the cover portion and the LiDAR sensor.

The LiDAR sensor may include a transmitter emitting light and a receiver receiving light, and the frame may include a central frame, and the central frame may be disposed between a first optical axis of the transmitter and a second optical axis of the receiver.

The frame may have elasticity.

According to an aspect of the present disclosure, a vehicle includes a vehicle body, and a lamp assembly disposed in a corner region of the vehicle body, wherein the lamp assembly includes a light guide including a light-emitting portion and a cover portion disposed to be spaced apart from the light-emitting portion, and a LiDAR sensor, and wherein the LiDAR sensor is disposed to directly face a rear surface of the cover portion.

The lamp assembly may be disposed as a plurality of lamp assemblies, and each of the plurality of lamp assemblies may be respectively disposed in a plurality of corner regions of the vehicle body.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 illustrates a vehicle to which a lamp assembly according to an embodiment of the present disclosure is applied.

FIG. 2 illustrates a lamp assembly according to an embodiment of the present disclosure.

FIG. 3 is an exploded view of FIG. 2.

FIG. 4 is a perspective view illustrating a lamp portion and a LiDAR sensor according to the present disclosure.

FIG. 5 is an exploded view of FIG. 4.

FIG. 6 is a perspective view illustrating a light guide.

FIG. 7 is a cross-section taken along line A-A′ of FIG. 4, including a structure of a cover portion according to a first embodiment.

FIGS. 8 and 9 are views illustrating an effect of a structure of a cover portion according to a first embodiment.

FIG. 10 is a cross-section taken along line A-A′ of FIG. 4, including a structure of a cover portion according to a second embodiment.

FIG. 11 illustrates a cover portion in which a tilt angle is 0.

FIG. 12 illustrates a cover portion in which a tilt angle is greater than 0.

FIG. 13 illustrates a reflection angle of stray light according to a tilt angle.

FIG. 14 illustrates a frame disposed in front of a LiDAR sensor, together with a lamp portion.

FIG. 15 illustrates a frame taken along line B-B′ of FIG. 4.

### DETAILED DESCRIPTION

Since the present disclosure may have various changes and may have various embodiments, specific embodiments are illustrated in the drawings and described in detail. However, this is not intended to limit the present disclosure to specific embodiments, it should be understood to include all modifications, equivalents, and substitutes included in the spirit and scope of the present disclosure.

Terms such as first, second, etc. may be used to describe various elements, but the elements should not be limited by the terms. The above terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

Terms such as “˜unit, ˜portion, ˜part, or the like” may be used to describe various components, but the components should not be limited by the terms. The terms may refer to not only physically/visibly distinct components, but also to describing a function or a configuration of a portion corresponding thereto even if distinction/division is not clear.

The terms used in the present application may be only used to describe specific embodiments, and may not be intended to limit the present disclosure. The singular expression may include the plural expression unless the context clearly dictates otherwise. In the present application, terms such as “comprise,” “include,” “have,” and the like are intended to designate that a feature, a number, an operation, an operation, a component, a part, or a combination thereof described in the specification exists, but it should be understood that existence or addition of one or more other features, numbers, operations, components, parts, or combinations thereof are excluded in advance.

Unless defined otherwise, all terms used herein, including technical or scientific terms, have the same meaning as commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present disclosure.

In this specification, a vehicle refers to various vehicles that move a transported object such as a person, an animal, an object, or the like from a starting point to a destination. Such vehicles are not limited to vehicles that run on roads or tracks. In addition, vehicles may include those that use fossil fuels such as gasoline, petrol, or the like, as well as those that use secondary batteries that use electricity stored in batteries, etc., and those that use future fuels such as hydrogen.

In the description below, the terms “in front of,” “a front portion,” “behind,” “a rear portion,” “lateral,” “side,” “forward,” “rearward,” “vertical (direction),” “on,” “upper,” “an upper portion,” “below,” “lower,” “a lower portion,” “left and right,” or the like, used in relation to a direction, may be defined based on a vehicle or a vehicle body. In addition, the terms such as first, second, etc., may be used to describe various components, but these components are not limited in order, size, location, or importance by the terms such as first, second, etc., and may be named only for the purpose of distinguishing one component from another.

Hereinafter, with reference to the attached drawings, a preferred embodiment of the present disclosure will be described in more detail.

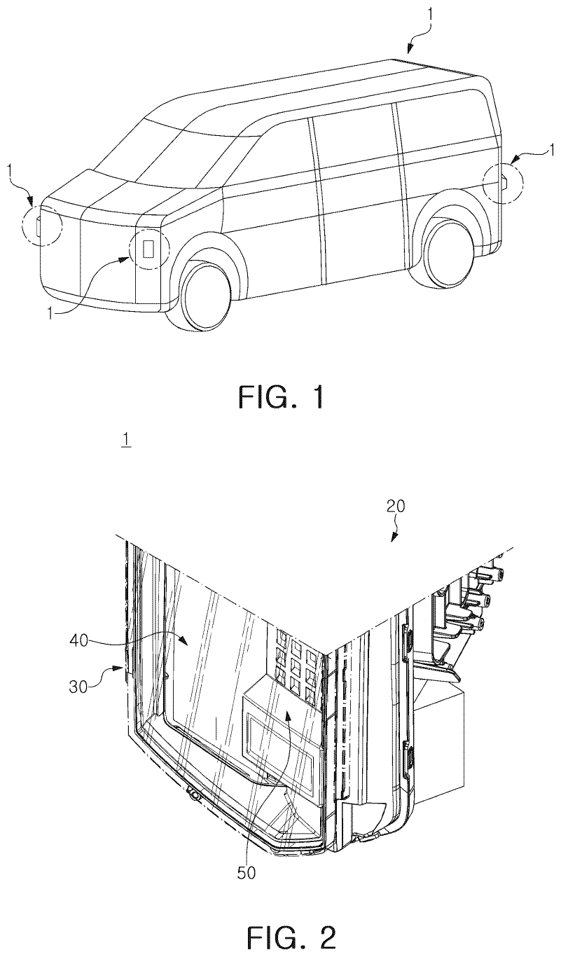

FIG. 1 illustrates a vehicle to which a lamp assembly according to an embodiment of the present disclosure is applied. A lamp assembly 1 according to the present disclosure may include a LiDAR sensor 10. The LiDAR sensor 10 of the lamp assembly 1 may be for sensing an object around a vehicle. Therefore, it is preferable that the lamp assembly 1 is disposed in a corner region of the vehicle body. Specifically, the lamp assembly 1 may be disposed as a plurality of lamp assemblies 1, and a portion of the plurality of lamp assemblies 1 may be disposed in corner regions at both sides of a front portion of the vehicle body, and a different portion of the plurality of lamp assemblies 1 may be disposed in corner regions at both sides of a rear portion of the vehicle.

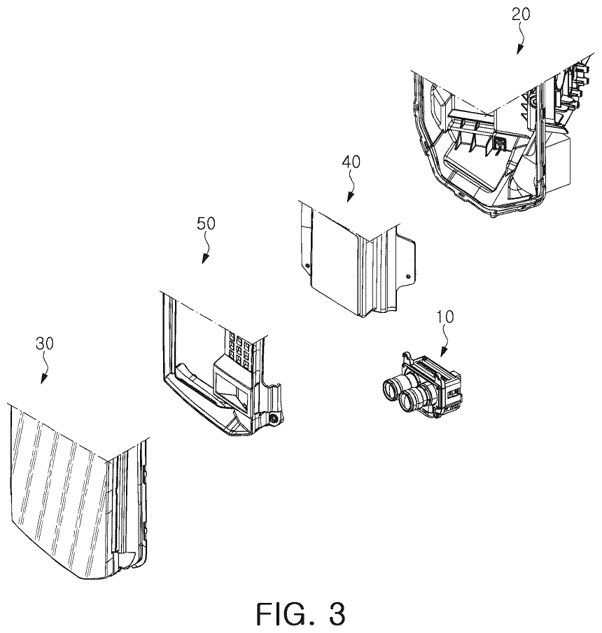

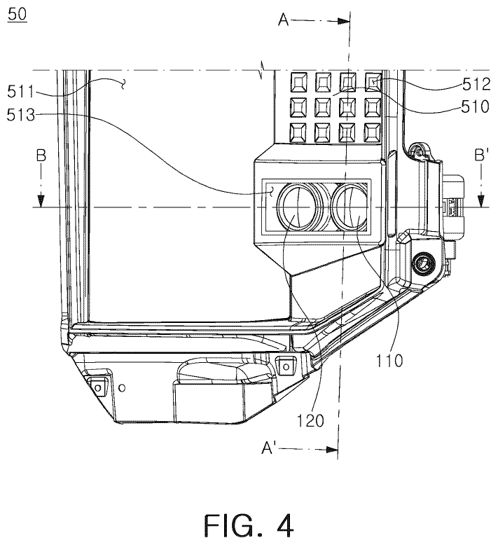

FIG. 2 illustrates a lamp assembly according to an embodiment of the present disclosure, and FIG. 3 is an exploded view of FIG. 2. Referring to FIGS. 2 and 3, a lamp assembly 1 may include a housing 20, a shield cover 30, a headlamp 40, a lamp portion 50, and a LiDAR sensor 10.

The housing 20 and the shield cover 30 may form an exterior of the lamp assembly 1. A space may be formed to have the housing 20. At least a portion of a configuration for an operation of the lamp assembly 1 may be disposed in the housing 20.

The shield cover 30 may be disposed in front of the housing 20. The headlamp 40 and the lamp portion 50 may be disposed in a space between the shield cover 30 and the housing 20. The shield cover 30 may be formed of a transparent material. Therefore, light from the headlamp 40 and the lamp portion 50 may pass through the shield cover 30. In addition, light (infrared light) emitting from the LiDAR sensor 10 described below and light (infrared light) entering the LiDAR sensor 10 may pass through the shield cover 30.

The housing 20 may be disposed in the vehicle body, and may not be exposed externally. The shield cover 30 may be exposed externally. The shield cover 30 may protect a portion of components of the lamp assembly 1 disposed between the housing 20 and the shield cover 30 from external impact.

The headlamp 40 may be disposed between the housing 20 and the shield cover 30. Since the headlamp 40 may be disposed to secure a driver's field of vision, brightness of light may be greater than brightness of the lamp portion 50, and a lens, a reflector, or the like may be disposed to shine the light to reach a relatively distant place.

The lamp portion 50 may provide vehicle information externally, using a tail lamp, a side lamp, a fog lamp, a turn lamp, or the like.

The LiDAR sensor 10 may be disposed in the housing 20. The LiDAR sensor 10 may be disposed as a portion of the lamp assembly 1. The LiDAR sensor 10 may be disposed behind the lamp portion 50. A front portion of the LiDAR sensor 10 may be disposed to face the shield cover 30 of the lamp assembly 1.

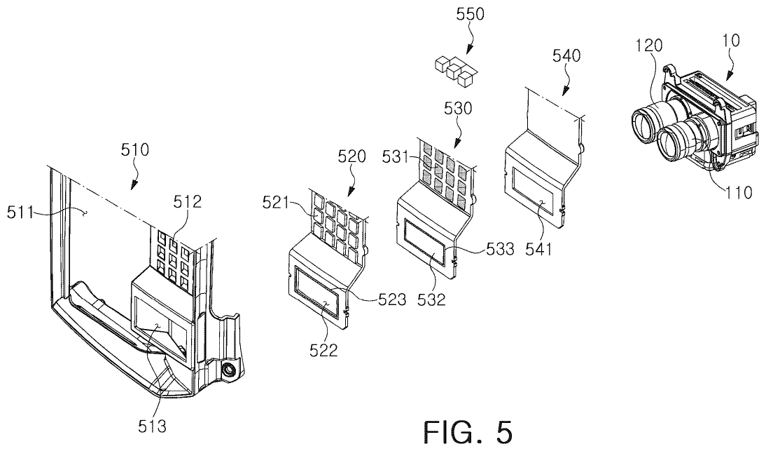

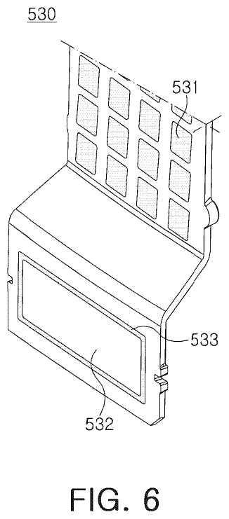

FIG. 4 is a perspective view illustrating a lamp portion and a LiDAR sensor according to the present disclosure, and FIG. 5 is an exploded view of FIG. 4. Referring to FIGS. 4 and 5, a structure of a lamp portion 50 and arrangement of a LiDAR sensor 10 will be described.

The lamp portion 50 may include a bezel unit 510, a lens unit 520, a light guide 530, and a reflector 540. The bezel unit 510, the lens unit 520, the light guide 530, and the reflector 540 may be disposed sequentially. The bezel unit 510, the lens unit 520, the light guide 530, and the reflector 540 may be disposed in the optical axis direction of the LiDAR sensor 10.

The bezel unit 510 may include a first region 511. The first region 511 may be a region penetrating the bezel unit 510. A headlamp 40 may be disposed in the first region 511.

A hole 512 may be disposed in the bezel unit 510. The hole 512 may be configured as a plurality of holes 512. The plurality of holes 512 may be aligned in horizontal and vertical directions. Light generated from a light source 550 of the lamp portion 50 may be exposed through the plurality of holes 512.

A window may be disposed in the bezel unit 510. The window disposed in the bezel unit 510 may be referred to as a first window 513. The first window 513 may be disposed adjacent to the plurality of holes 512 disposed in the bezel unit 510. Specifically, the first window 513 may be disposed adjacent to a hole 512 disposed in an outermost corner, among the plurality of holes 512 disposed in the bezel unit 510.

The first window 513 may be formed to have a tetragonal shape, or alternatively may be formed to have a circular shape. The first window 513 may be formed to have a shape, other than the tetragonal shape, as long as it has a structure suitable for infrared rays of the LiDAR sensor 10 to pass through. The first window 513 may be disposed to overlap a cover portion 532 of the light guide 530 to be described below in the optical axis direction of the LiDAR sensor 10. For example, the cover portion 532 of the light guide 530 may be visible through the first window of the bezel unit.

The bezel unit 510 may be configured to block light in a portion excluding the first region 511, the hole 512, and the first window 513. Therefore, the bezel unit 510 may be formed of an opaque material through which visible light cannot pass.

The lens unit 520 may be disposed behind the bezel unit 510. A lens cell 521 may be disposed in the lens unit 520. The lens cell 521 may be configured as a plurality of lens cells 521. The plurality of lens cells 521 may be aligned in the horizontal and vertical directions. Light generated from the light source 550 of the lamp portion 50 may pass through each of the plurality of lens cells 521.

The plurality of lens cells 521 disposed in the lens unit 520 may overlap the plurality of holes 512 disposed in the bezel unit 510. Therefore, light passing through the lens cells 521 may be exposed through the holes 512.

A window may be disposed in the lens unit 520. The window of the lens unit 520 may be referred to as a second window 522. The second window 522 may be disposed adjacent to the plurality of lens cells 521 disposed in the lens unit 520. Specifically, the second window 522 may be disposed adjacent to a lens cell 521 disposed in an outermost corner, among the plurality of lens cells 521 disposed in the lens unit 520.

The second window 522 may be formed to have a tetragonal shape, or alternatively may be formed to have a circular shape. The second window 522 may be formed to have a shape, other than the tetragonal shape, as long as it has a structure suitable for infrared rays of the LiDAR sensor 10 to pass through. The second window 522 may be disposed to overlap the cover portion 532 of the light guide 530 to be described below. For example, the cover portion 532 of the light guide 530 may be visible externally through the second window 522 of the lens unit 520.

A size of the second window 522 may be smaller than a size of the first window 513. Therefore, an edge region of the second window 522 may be exposed through the first window 513. The edge region of the second window may be referred to as a first edge region 523. The first edge region 523 may be visible externally through the first window 513. The first edge region 523 may overlap a second edge region 533 of the cover portion 532 of the light guide 530 to be described later.

The light guide 530 may be disposed behind the lens unit 520. The light guide 530 may be formed of a transparent material. The material of the light guide 530 may be, for example, polycarbonate.

The light source 550 may be disposed on one side of the light guide 530. The light source 550 may be an organic light-emitting diode. Light of the light source 550 illuminates a side surface of the light guide 530, and the light may travel along an internal space of the light guide.

The reflector 540 may be disposed behind the light guide 530. The reflector 540 may be formed of an opaque material. Therefore, light passing through the light guide 530 by the reflector 540 may be prevented from leaking from the light guide 530 in a rearward direction. A window may be disposed at the reflector 540. The window of the reflector may be referred to as a third window 541. The third window 541 may be disposed to overlap the first window 513 and the second window 522 in an optical axis direction of the LiDAR sensor 10.

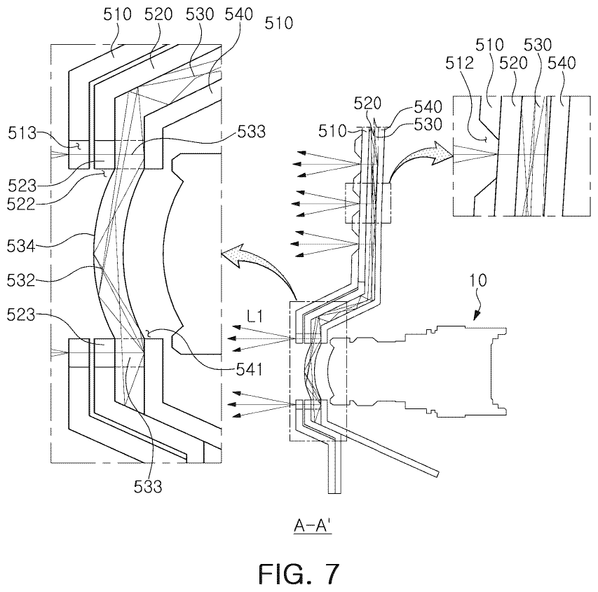

FIG. 6 is a perspective view illustrating a light guide. A light-emitting portion 531 and a cover portion 532 may be disposed in a light guide 530. The light-emitting portion 531 may be disposed as a plurality of light-emitting portions 531. The plurality of light-emitting portions 531 may be aligned in the horizontal and vertical directions. A surface of the light-emitting portion 531 may include a corrosion-treated corrosion surface. For example, a surface of the light-emitting portion 531 may have a rough surface. Therefore, at least a portion of light formed by a light source 550 and passing through the light guide may be diffusely reflected by the light-emitting portion 531, and the light may be focused on the light-emitting portion 531.

The cover portion 532 may be disposed to be spaced apart from the light-emitting portion 531. The cover portion 532 may be disposed so as to overlap a first window 513 of a bezel unit 510 and a second window 522 of a lens unit 520 in an optical axis direction of a LiDAR sensor. The cover portion 532 allows light from a transmitter 110 of the LiDAR sensor 10, and light entering a receiver 120 of the LiDAR sensor 10 to pass through the same.

An edge region around the cover portion 532 may be referred to as a second edge region 533. A surface of the second edge region 533 may be a corrosion-treated corrosion surface. Therefore, light of the light source 550 passing through the light guide 530 may be diffusely reflected in the second edge region 533 of the cover portion 532, and the light may be focused on the second edge region 533 of the cover portion 532. An area of the second edge region 533 of the cover portion 532 may be smaller than an area of the first window 513 of the bezel unit 510. For example, when viewed from the outside, the second edge region 533 of the cover portion 532 may be seen through the first window.

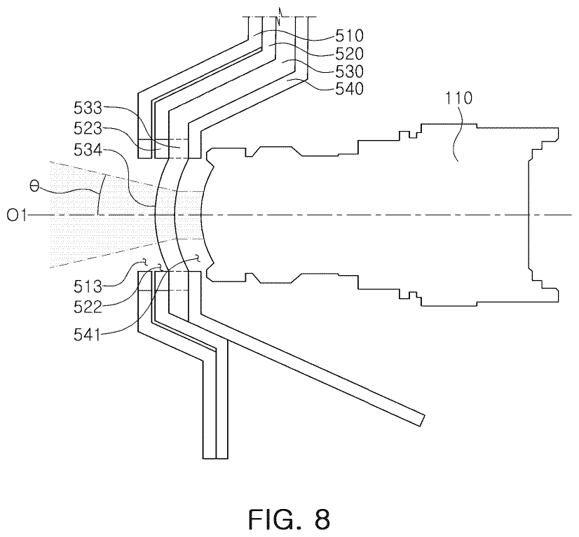

FIG. 7 is a cross-section taken along line A-A′ of FIG. 4, including a structure of a cover portion according to a first embodiment. An operation of a lamp will be described with reference to FIGS. 4, 5, and 7. Light from a light source 550 may pass through a light guide 530. A portion of light L1 passing through the light guide 530 may be diffusely reflected by a light-emitting portion 531 of the light guide 530, and may be focused on the light-emitting portion 531. The light L1 focused on the light-emitting portion 531 may be collected by a lens cell 521 of a lens unit 520, to be clear, when viewed from the outside. The light L1 collected by the lens cell 521 may be exposed externally through a hole 512 of a bezel unit 510.

A different portion of the light passing through the light guide 530 may be diffusely reflected at a second edge region 533 of a cover portion 532, and may be focused on the second edge region 533. The light L1 focused on the second edge region 533 of the cover portion 532 may be collected by the lens unit 520, to be clear light, when viewed from the outside. Since an area of a first window 513 of the bezel unit 510 may be formed to be greater than an area of the second edge region 533 of the cover portion 532, the light L1 focused on the second edge region 533 of the cover portion may be exposed through the first window 513.

Since the cover portion 532 may be disposed such that a transmitter 110 and a receiver 120 of a LiDAR sensor 10 overlap each other, when viewed from the outside, the light of the edge region of the cover portion 532 may be formed along a periphery of the transmitter 110 and a periphery of the receiver 120 of the LiDAR sensor 10.

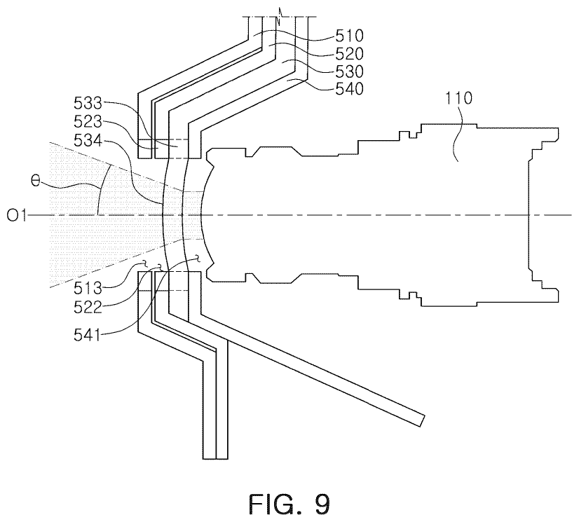

FIGS. 8 and 9 are views illustrating an effect of a structure of a cover portion according to a first embodiment. The cover portion according to the first embodiment will be explained with reference to FIGS. 7 to 9.

A cover portion 532 may be exposed externally through a first window 513 of a bezel unit 510. A transmitter 110 and a receiver 120 of a LiDAR sensor 10 may be disposed behind the cover portion 532. Therefore, infrared rays emitting from the transmitter 110 of the LiDAR sensor 10 and infrared rays entering the receiver 120 may pass through the cover portion 532.

A convex portion 534 may be disposed in front of the cover portion 532. The cover portion 532 may perform a role similar to a convex lens. Therefore, the cover portion 532 may collect light emitting from the LiDAR sensor 10. For example, the convex portion of the cover portion 532 may narrow an irradiation angle θ of the light emitting from the LiDAR sensor 10.

When comparing FIG. 8 and FIG. 9, curvature of the convex portion 534 of FIG. 8 may be formed to be greater than curvature of the convex portion 534 of FIG. 9. As curvature of the convex portion 534 increases, an irradiation angle θ of light of the transmitter 110 may become narrower. Therefore, as the curvature of the convex portion 534 increases, a size of an area that the LiDAR sensor 10 can sense may decrease, but a distance that the LiDAR sensor 10 can sense may increase.

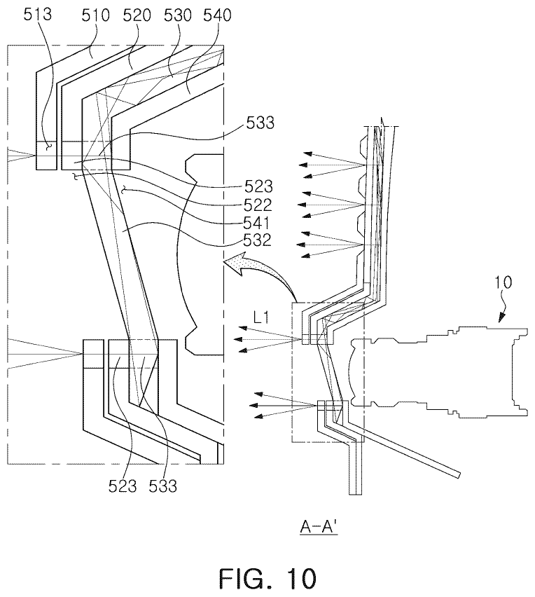

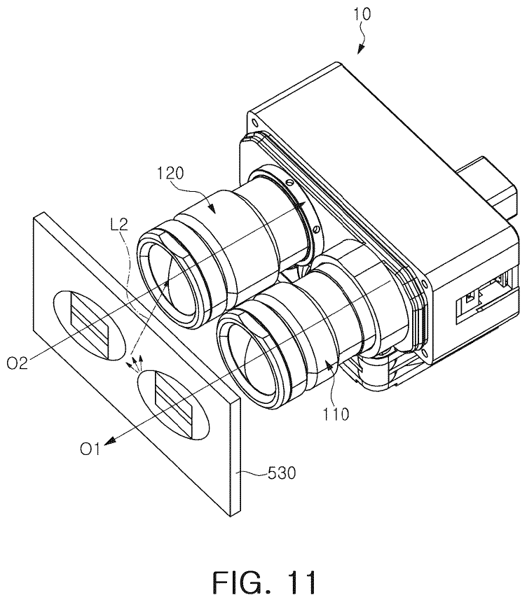

FIG. 10 is a cross-section taken along line A-A′ of FIG. 4, including a structure of a cover portion according to a second embodiment. FIGS. 11 to 13 are views illustrating an effect of a cover portion according to a second embodiment.

A cover portion 532 may include a slope. The cover portion 532 may be inclined with respect to a LiDAR sensor 10. The cover portion 532 may be inclined with respect to a direction, orthogonal to an optical axis of the LiDAR sensor 10. For example, the optical axis of the LiDAR sensor 10 and the cover portion 532 may form an obtuse angle.

An angle at which the cover portion 532 is tilted based on a virtual line, perpendicular to the optical axis of the LiDAR sensor 10, may be referred to as a tilt angle θ1.

FIG. 11 illustrates a cover portion 532 in which a tilt angle θ1 is 0. A portion of light emitting from a transmitter 110 of a LiDAR sensor 10 may not pass through the cover portion 532, and may be reflected. The light reflected from the cover portion 532 may be introduced into a receiver 120 of the LiDAR sensor 10.

A light sensor (single photon avalanche diode (SPAD)) may be disposed in the receiver 120 of the LiDAR sensor 10. Portion of the light reflected from the cover portion 532 (hereinafter referred to as stray light) may reach the light sensor. When stray light L2 reaches the light sensor, a ghost phenomenon may occur. For example, the LiDAR sensor 10 may malfunction by sensing an object not actually existing due to stray light L2.

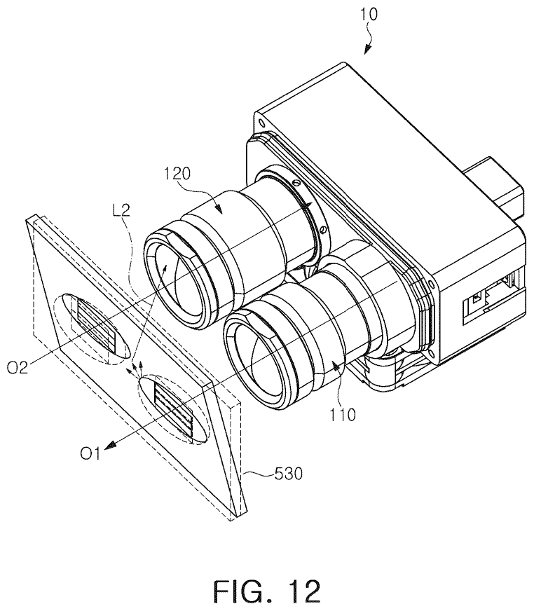

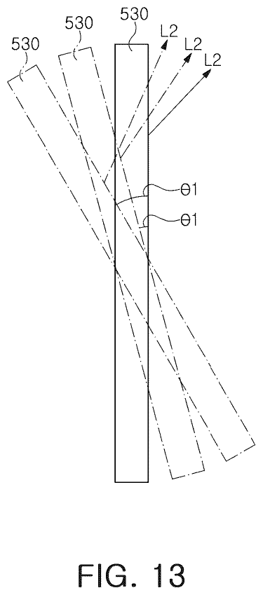

FIG. 12 illustrates a cover portion 532 in which a tilt angle is greater than 0, and FIG. 13 illustrates a reflection angle of stray light according to a tilt angle.

As a tilt angle θ1 of a cover portion 532 increases, a reflection angle of stray light L2 may also increase. As the reflection angle of the stray light L2 increases, the stray light L2 may reach a location further from a center of a light sensor. For example, by adjusting the tilt angle θ1, the stray light L2 may reach a region, other than the light sensor, thereby suppressing occurrence of a ghost phenomenon.

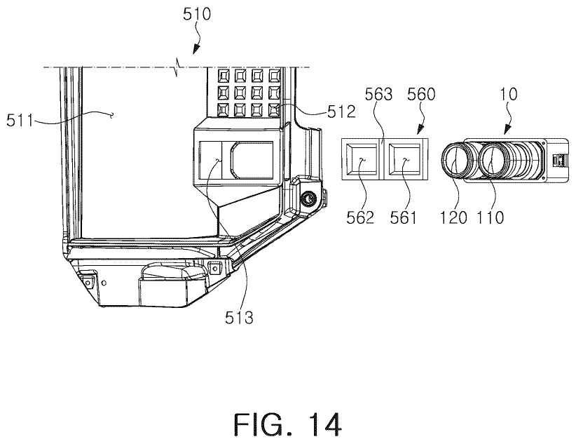

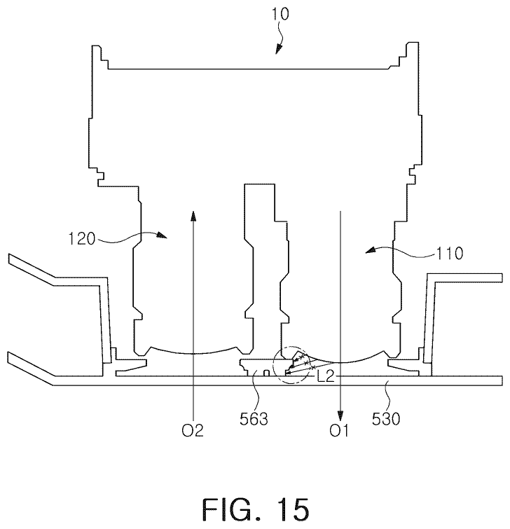

FIG. 14 illustrates a frame disposed in front of a LiDAR sensor, together with a lamp portion, and FIG. 15 illustrates a frame taken along line B-B′ of FIG. 4.

A frame 560 may be disposed in front of a LiDAR sensor 10. The frame 560 may be a tetragonal window. The frame 560 may include a first opening 561 and a second opening 562. Light from a transmitter 110 of the LiDAR sensor 10 may pass through the first opening 561, and light entering a receiver 120 of the LiDAR sensor 10 may pass through the second opening 562.

The frame 560 may include a central frame 563. The central frame 563 may refer to a portion located between the transmitter 110 and the receiver 120 of the LiDAR sensor 10. For example, the central frame 563, which may be a portion of the frame 560, may be located between a first optical axis O1 of the transmitter 110 and a second optical axis O2 of the receiver 120.

The central frame 563 may be disposed between the first optical axis O1 and the second optical axis O2, such that stray light L2 reflected from a cover portion 532, among light emitted from the transmitter 110, may be blocked from entering the receiver 120. Therefore, the central frame 563 may prevent occurrence of a ghost phenomenon in the light sensor.

The frame 560 may be disposed between the cover portion 532 of a light guide 530 and the LiDAR sensor 10. The frame 560 may be attached to a rear surface of the cover portion 532. The frame 560 may be formed as an elastic body. Specifically, the frame 560 may include a rubber material or a silicone material. The frame 560 may face the LiDAR sensor 10. The frame 560 may be disposed to contact at least a portion of the LiDAR sensor 10. When a vehicle is driven, vibration, slight distortion of a vehicle body, or the like may occur. The frame 560 may have elasticity, and may thus prevent direct contact between the light guide 530 and the LiDAR sensor 10, and prevent damage to the light guide 530 and the LiDAR sensor 10.

In a lamp assembly of the present disclosure, a LiDAR sensor may be embedded in the lamp assembly, which has an advantage of space utilization, and light of a lamp may be turned on around a transmitter and a receiver of the LiDAR sensor. In addition, a sensing range of the LiDAR sensor may be adjusted by adjusting curvature of a convex portion of a cover portion, and the ghost phenomenon may be reduced by tilting the cover portion relative to the optical axis of the LiDAR sensor.

A lamp assembly according to an embodiment of the present disclosure may use surroundings of a cover portion acting as a black cover of a LiDAR sensor, as a lamp, may adjust a sensing range of the LiDAR sensor, and may reduce a ghost phenomenon of the LiDAR sensor

Effects of the present disclosure are not limited to those described above, and other effects not mentioned may be clearly recognized by those skilled in the art from the description above.

While example embodiments have been shown and described above, it will be apparent to those skilled in the art that modifications and variations could be made without departing from the scope of the present disclosure as defined by the appended claims.

1. A lamp assembly comprising:
a light source;
a light guide through which light from the light source passes; and
a LiDAR sensor;
wherein the light guide includes a light-emitting portion and a cover portion positioned apart from the light-emitting portion;
wherein the LiDAR sensor is positioned adjacent a rear surface of the cover portion; and
wherein an edge region of the cover portion is a corrosion-treated corrosion surface.

2. The lamp assembly of claim 1, further comprising a bezel unit positioned adjacent to the light guide, wherein a first window is positioned in the bezel unit aligned with an optical axis direction of the LiDAR sensor and the cover portion, and wherein an area of the first window is greater than an area of the cover portion.

3. The lamp assembly of claim 2, wherein the edge region of the cover portion is visible through the first window.

4. The lamp assembly of claim 2, further comprising a lens unit positioned between the light guide and the bezel unit.

5. The lamp assembly of claim 4, wherein a lens cell is disposed in the lens unit, and the lens cell faces the light-emitting portion.

6. The lamp assembly of claim 2, further comprising a reflector positioned between the light guide and the LiDAR sensor.

7. The lamp assembly of claim 1, wherein a surface of the light-emitting portion is a corrosion-treated corrosion surface.

8. The lamp assembly of claim 1, wherein the LiDAR sensor directly faces the cover portion.

9. The lamp assembly of claim 1, wherein a front portion of the cover portion is convex.

10. The lamp assembly of claim 1, wherein the cover portion is disposed obliquely.

11. The lamp assembly of claim 10, wherein the cover portion forms a tilt angle with a virtual plane, the tilt angle being perpendicular to an optical axis of the LiDAR sensor.

12. The lamp assembly of claim 10, wherein the cover portion forms an obtuse angle with an optical axis of the LiDAR sensor.

13. The lamp assembly of claim 1, further comprising a frame positioned between the cover portion and the LiDAR sensor.

14. The lamp assembly of claim 13, wherein the LiDAR sensor includes a transmitter configured to emit light and a receiver configured to receive light, the frame includes a central frame, and the central frame is positioned between a first optical axis of the transmitter and a second optical axis of the receiver.

15. The lamp assembly of claim 13, wherein the frame has elasticity.

16. A vehicle comprising:
a vehicle body; and
a lamp assembly positioned in a corner region of the vehicle body;
wherein the lamp assembly includes:
a light guide including a light-emitting portion and a cover portion positioned apart from the light-emitting portion; and
a LiDAR sensor;
wherein the LiDAR sensor directly faces a rear surface of the cover portion.

17. The vehicle of claim 16, wherein the lamp assembly comprises a plurality of lamp assemblies, the corner region comprises a plurality of corner regions, and wherein each of the plurality of lamp assemblies is positioned in each of a plurality of corner regions of the vehicle body.

18. The vehicle of claim 16, wherein the corner region comprises a housing forming a first exterior of the lamp assembly a shield cover forming a second exterior of the lamp assembly.

19. The vehicle of claim 18, wherein a headlamp is positioned between the housing and the lamp portion.

20. The vehicle of claim 16, wherein the lamp assembly further comprises a bezel unit positioned adjacent to the light guide, wherein a first window is positioned in the bezel unit aligned with an optical axis direction of the LiDAR sensor and the cover portion, and wherein an area of the first window is greater than an area of the cover portion.
